(19) United States
(12) Patent Application Publication
(10) Pub. No.: US 2014/0035853 A1
(43) Pub. Date: Feb. 6, 2014

(54) METHOD AND APPARATUS FOR PROVIDING USER INTERACTION BASED ON MULTI TOUCH FINGER GESTURE

(71) Applicant: Samsung Electronics Co., Ltd., Gyeonggi-do (KR)

(72) Inventors: Dongmin OK, Seoul (KR); Chanyoung MOON, Gyeonggi-do (KR)

(73) Assignee: Samsung Electronics Co., Ltd., Gyeonggi-do (KR)

(21) Appl. No.: 13/960,004

(22) Filed: Aug. 6, 2013

(30) Foreign Application Priority Data
Aug. 6, 2012 (KR) 10-2012-0085643

(51) Int. Cl. G06F 3/041

(52) U.S. Cl. CPC G06F 3/0416
USPC 345/173

(57) ABSTRACT

In an apparatus having a touch screen, a user interaction method includes detecting a multi touch having three or more contact points from the touch screen on which an app execution screen is displayed, detecting a movement of the multi touch, determining whether the movement of the multi touch is a pinch-in, and if the movement of the multi touch is a pinch-in, performing at least one of an app execution termination function and a touch screen turn-off function.

### CROSS RELATED APPLICATION

This application claims the benefit of priority under 35 U.S.C. §119(a) of a Korean patent application filed on Aug. 6, 2012 in the Korean Intellectual Property Office and assigned Serial No. 10-2012-0085643, the entire disclosure of which is hereby incorporated by reference.

### BACKGROUND

1. Field of the Invention

The present disclosure relates generally to a multi touch based user interaction and, more particularly, to a method and apparatus for providing a user interaction based on a multi touch finger gesture.

2. Description of the Related Art

The market of mobile devices is rapidly growing due to various designs and applications that induce customers to buy products and/or services. In particular, unlike conventional mobile phones that use given functions only, recent mobile devices can install a great variety of applications in connection with taking pictures, recording, playing, online games, receiving broadcast, social network service (SNS), and the like, downloaded from online markets, etc. Furthermore, recent advances in performance of a central processing unit (CPU) and in capacity of a memory enable mobile devices to perform multitasking that allows the execution of various applications simultaneously.

Conventionally, multitasking is realized by means of interrupt technique. More particularly, a mobile device in which two or more applications are running at the same time allocates separate individual memory regions to respective application programs. Only when an interrupt call occurs, a running application can render its user interface to a display panel. Even if a user closes a currently running application, the application is not actually terminated, but the screen displayed on the display panel is changed from an app execution screen to a home screen.

Therefore, a user who desires to completely terminate the execution of a certain application should access a task management menu and take proper termination steps. Unfortunately, this may be troublesome to a user or involve multiple or complicated steps.

Additionally, since a mobile device that performs multitasking allocates simultaneously memory regions to respective running applications, excessive occupation of memory may lower the performance of entire system or make the system look as if stopped.

### SUMMARY

Accordingly, the present invention, in one embodiment, addresses the above-mentioned problems and/or disadvantages and to offer at least the advantages described below.

An aspect of the present invention is to provide a user interaction method and apparatus which can completely terminate a running application process or turn off a screen of a mobile device by using a multi touch finger gesture.

According to one aspect of the present invention, a user interaction method is provided for an apparatus having a touch screen. The method includes detecting a multi touch having three or more contact points from the touch screen on which an app execution screen is displayed; detecting a movement of the multi touch; determining whether the movement of the multi touch is a pinch-in; and thereafter, performing at least one of an app execution termination function and a touch screen turn-off function.

According to another aspect of the present invention, a user interaction apparatus is provided which includes a touch screen configured to display a screen for an interaction with a user; a memory unit configured to store information about a multi touch gesture and information about a particular function corresponding to the multi touch gesture; and a control unit configured to detect a multi touch having three or more contact points from the touch screen on which an app execution screen is displayed, to detect a movement of the multi touch, to determine whether the movement of the multi touch is a pinch-in, and to perform at least one of an app execution termination function and a touch screen turn-off function if the movement of the multi touch is a pinch-in.

In such embodiments, the user may simply terminate the execution of an application or turn off a display panel and a touch panel by using a multi touch finger gesture. In at least one embodiment, this invention allows a user to simply turn on a display panel by using a multi touch finger gesture while the display panel is turned off. Therefore, although several applications are executed through multitasking in a mobile device, a memory of the mobile device can be effectively managed using a multi touch finger gesture. Also, a simple process of turning off a touch screen may improve convenience in use.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a block diagram illustrating an apparatus in accordance with an embodiment of the present invention.

FIG. 2 is a flow diagram illustrating one method by which the user may interact with an apparatus of the present invention.

FIG. 3 is a flow diagram illustrating one method by which a user may interact with an apparatus of the present invention.

FIG. 4 is a flow diagram illustrating one method by which a user may interact an apparatus of the present invention.

FIG. 5 shows multiple screenshots associated with a user interaction method in accordance with an embodiment of the present invention.

FIG. 6 shows additional screenshots associated with a user interaction method in accordance with another embodiment of the present invention.

FIG. 7 shows screenshots associated with a user interaction method in accordance with still another embodiment of the present invention.

FIG. 8 shows screenshots associated with a user interaction method in accordance with yet another embodiment of the present invention.

### DETAILED DESCRIPTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

For the purposes of clarity and simplicity, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

In this disclosure, the term ‘application’, or ‘app’ refers to software designed to carry out a particular task and run in a mobile device by occupying a memory. Applications may involve all kinds of programs except an operating system (OS).

In this disclosure, the term ‘home screen’ refers to a screen which is displayed on a touch screen and in which one or more icons for executing applications or invoking functions of a mobile device are arranged or otherwise displayed.

In this disclosure, the term ‘app execution screen’ refers to a screen which is displayed on a touch screen when any application is running as occupying a memory of a mobile device.

In this disclosure, the term ‘pinch-in’ refers to a movement of a multi touch, having three or more contact points, during which the contact points converge on a touch screen. More particularly, the contact points start in positions where each is contact point is spaced from each other contact point, and such movement brings the contact points closer together. It is not necessary that any one contact point merges with any other contact point. In a preferred embodiment, the movement of the each of contact points is toward a point centrally (or nearly centrally) located between the contact points.

In this disclosure, the term ‘pinch-out’ refers to a movement of a multi touch which has three or more contact points, during which the contact points diverge on a touch screen. More particularly, the contact points start in positions where each is contact point is spaced from each other contact point, and such movement increases the distance between the contact points. In a preferred embodiment, the movement of the each of contact points is away from a point centrally (or nearly centrally) located between the contact points.

In this disclosure, the term ‘app execution termination’ refers to a state or an action which terminated the execution of a selected application and preferably its related processes such that the application may not occupy a memory.

Using a multi touch finger gesture, the present invention preferably provides a user interaction, such as a function, to completely terminate a process of application, a function to turn off a display screen, or to turn on a display screen in a state where the display screen is turned off.

A user interaction method and apparatus in accordance with the present invention may be applied to various types of mobile devices such as a cellular phone, a smart phone, a tablet PC, a handheld PC, a PMP (portable multimedia player), a PDA (personal digital assistant), and the like.

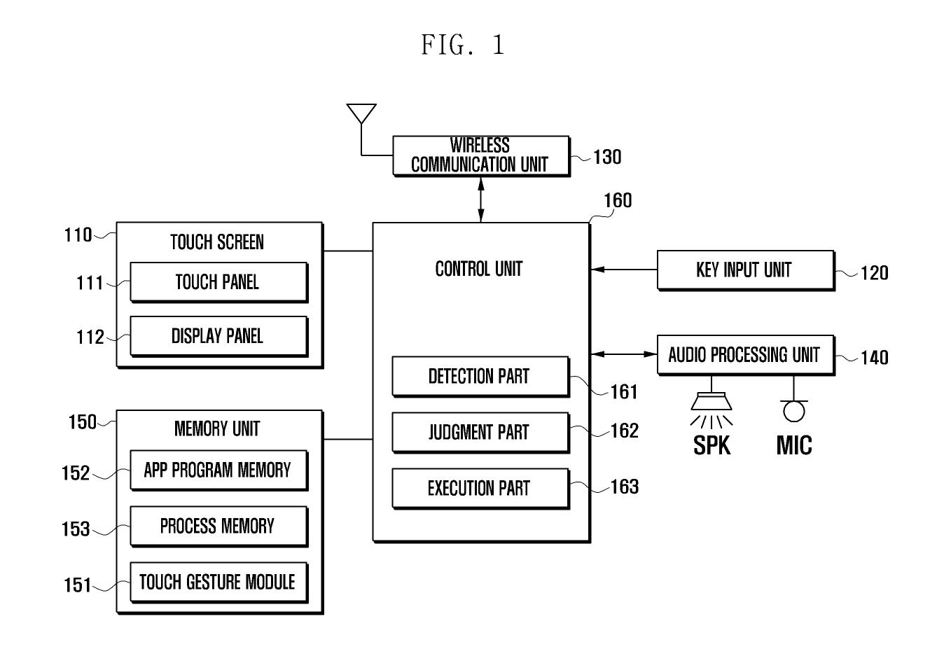

FIG. 1 is a block diagram illustrating an apparatus in accordance with the invention, designed for users' interaction.

Referring to FIG. 1, the user interaction providing device includes a touch screen 110, a key input unit 120, a wireless communication unit 130, an audio processing unit 140, a memory unit 150, and a control unit 160.

The touch screen 110 may include a touch panel 111 and a display panel 112 which are used for a user interaction with a mobile device. The touch panel 111 creates a touch input signal in response to a user input (e.g. a finger touch) and delivers the signal to the control unit 160. The control unit 160, typically including a processor and/or a microprocessor, then detects user's touch or touch gesture from the touch input signal and performs a particular function, corresponding to the detected touch or touch gesture, of a mobile device.

In one embodiment of this invention, if a multi-finger pinch-in gesture occurs on the touch screen 110 (or a touch pad, not shown), the control unit 160 may terminate the execution of any presently running application or turn off the touch screen 110. In the latter case, the control unit 160 may simultaneously turn off both the touch panel 111 and the display panel 112 or turn off the display panel 112 only—leaving the touch panel 111 on and able to detect a touch or a gesture from the user. To turn off the touch screen 110, the control unit 160 may perform a process of stopping the supply of electric power to the touch screen 110. Meanwhile, the memory unit 150 may store information about a pinch-in gesture and information about a particular function which corresponds to a pinch-in gesture. For example, at least one of an app execution termination function and a touch screen turn-off function may be stored to be executed in correspondence with a pinch-in gesture.

In one embodiment, the pinch-in gesture may be associated with both the app termination function and the touch screen turn-off function, depending upon a setting in the memory unit. This setting can be either coded into the OS, or may be a setting that can be changed by the user by interacting with the OS.

In another embodiment of this invention, if a pinch-out gesture occurs on the touch panel 111 in a state where the display panel 112 only is turned off (i.e., where the touch panel 111 remains powered on), the control unit 160 may turn on the display panel 112. In this case, the memory unit 150 may store information about a pinch-out gesture and information about a particular function which corresponds to a pinch-out gesture. For example, a display panel turn-on function may be stored to be executed in correspondence with a pinch-out gesture. To turn on the touch screen 110, the control unit 160 may perform a process of resuming the supply of electric power to the touch screen 110. Also, after the display panel 121 is turned on, the control unit 160 may control the display panel 112 to display a home screen or an app execution screen which was displayed when the display panel was turned off. Alternatively, the control unit 160 may be programmed to perform a series of commands or functions upon detecting the instruction to power on the display panel 112. For example, the associated command may result in one or more sounds generated through the audio processing until 140 and/or executing a particular application stored in the app program memory 152. Again, such instructions can, for example, be coded into the OS or otherwise set by the user.

The touch panel 111 may be placed on the display unit 112 and have a touch sensor that detects a touched contact point and transmits a corresponding touch input signal to the control unit 160. The touch panel 111 may be formed of add-on type that indicates a placement on the display panel 112, or in-cell type that indicates an insertion in the display panel 112.

The touch panel 111 typically detects a multi touch from the touch screen 110, creates a touch input signal, and delivers the signal to the control unit 160. Then the control unit 160 recognizes the touch gesture by detecting a variation of touch input signal. At this time, the control unit 160 may detect a touch contact point, a touch move distance, a touch move direction, a touch speed, or the like. The control unit 160 may control the above-mentioned elements on the basis of a user gesture recognized by detecting touch input signals received from the touch screen.

User gestures are classified into a touch and a touch gesture. In addition, a touch gesture may include a tap, a double tap, a long tap, a drag, a drag-and-drop, a flick, a press, and the like. A touch refers to user's action to make a touch input tool (e.g., a finger or a stylus pen) be in contact with any point on the screen. A tap refers to an action to touch any point on the screen and then release (namely, touch-off) a touch input tool from the touch point without moving the touch input tool. A double tap refers to an action to tap twice any point on the screen. A long tap refers to an action to touch relatively longer than a tap and then release a touch input tool from the touch point without moving the touch input tool. A drag refers to an action to move a touch input tool in an arbitrary direction while maintaining a touch on the screen. A drag-and-drop refers to an action to drag and then release a touch input tool from the screen. A flick refers to an action to move a touch input tool more quickly than a drag and then release the touch input tool. A press refers to an action to touch and push any point on the screen through a touch input tool. Namely, a touch means a state where any contact occurs on the touch screen 110, and a touch gesture means a movement of touch which continues from touch-on to touch-off. Particularly, a multi touch means a state where any contact occurs simultaneously at two or more points on the touch screen. A multi touch gesture means a movement of multi touch which continues from touch-on to touch-off.

The touch panel 111 may use a capacitive type, a resistive type, an electromagnetic induction type, an infrared type, an ultrasonic type, or the like.

The display panel 112 may convert image data, received from the control unit 160, into analog signals and then display them thereon under the control of the control unit 160. The display panel 112 may provide various screens according to use of a mobile device, e.g., a lock screen, a home screen, an app execution screen, a menu screen, a keypad screen, and the like. The lock screen refers to an initial screen displayed when the screen of the display panel 112 is turned on. If a specific touch event defined for unlock occurs, the control unit 160 may change a current display screen from the lock screen to the home screen, the app execution screen, or the like. The home screen refers to a screen in which one or more icons for executing applications or invoking functions of a mobile device are arranged or otherwise displayed. When a user selects an application execution icon displayed on the home screen, the corresponding selected application is executed under the control of the control unit 160, and the display panel 112 displays an execution screen of the selected application. The control unit 160 may execute a plurality of applications simultaneously. Although two or more applications are executed at the same time, the display panel 112 may display a single app execution screen under the control of the control unit 160.

Although not a preferred embodiment, it is within the scope of the invention to have the display panel 112 display multiple app execution screens simultaneously, as part of a multi-window display.

The display panel 112 may be formed of any planar display panel such as LCD (liquid crystal display), OLED (organic light emitting diodes), AMOLED (active matrix OLED), or any other equivalent.

The key input unit 120 may include a plurality of input keys and function keys to receive user's input actions and to set up various functions. The function keys may have navigation keys, side keys, shortcut keys, and any other special keys or user-definable keys defined to perform particular functions. Additionally, the key input unit 120 may receive user's key manipulations for controlling a mobile device, create corresponding key input signals, and then deliver the signals to the control unit 160. Such key input signals may include power on/off signals, volume regulating signals, screen on/off signals, and the like. In response to the key input signals, the control unit 160 may control the above elements. Additionally, the key input unit 120 may include a QWERTY keypad, a 3*4 keypad, a 4*3 keypad, or any other keypad formed of many keys with typical or special key arrangement. When a mobile device supports the touch panel 111 in the form of full touch screen, the key input unit 120 may have only at least one side key, for power on/off or screen on/off, formed on any side of a device body.

The wireless communication unit 130 may perform a voice call, a video call, or a data communication between a mobile device and a wireless communication system under the control of the control unit 160. The wireless communication unit 130 may include an RF (radio frequency) transmitter that up-converts the frequency of an outgoing signal and then amplifies the signal, an RF receiver that amplifies with low-noise an incoming signal and down-converts the frequency of the signal, and the like. Additionally, the wireless communication unit 130 may include a mobile communication module (e.g., a 3rd generation mobile communication module, a 3.5th generation mobile communication module, or a 4th generation mobile communication module), a short-range communication module (e.g., a Wi-Fi module), and/or a digital broadcast module (e.g., a DMB module).

The audio processing unit 140, typically containing a subprocessor and/or a separate processor, may convert digital audio data, received from the control unit 160, into analog audio data and send such data to a speaker (SPK). The audio processing unit 140 may additionally convert analog audio data such as voice, received from a microphone (MIC), into digital audio data and send such data to the control unit 160.

The memory unit 150 may include a data region and a program region. The data region of the memory unit 150 may store data created, updated or downloaded in a mobile device. Additionally, the data region may store the above-mentioned various screens of a mobile device, such as the lock screen, the home screen, the app execution screen, the menu screen, and the keypad screen. The data region may additionally store a specific screen displayed on the display panel 112 at the time when any interrupt signal for multitasking occurs.

The data region of the memory unit 150 may include a touch gesture module 151, which is configured to store input gestures such as touch gestures and to store information about a particular function corresponding to each input gesture. One or more relations between such gesture information and corresponding function information may be defined depending on user's setting or otherwise defined in the OS of the device. In some embodiments, the touch gesture module 151 may store an input gesture for a pinch-in gesture and store, as a function corresponding to the pinch-in gesture, at least one of an app execution termination function and a touch screen turn-off function. In some embodiments, the touch gesture module 151 may store an input gesture for a pinch-out gesture and store, as a function corresponding to the pinch-out gesture, a touch screen turn-on function.

The program region of the memory unit 150 may include an app program memory 152 and a process memory 153. The app program memory 152 may store application programs required for performing functions of a mobile device. Specifically, the app program memory 152 may store an operating system (OS) for booting a mobile device, and various applications required for a call function, a video or music play function, an image display function, a camera function, a broadcast reception function, an audio recording function, a calculator function, a scheduler function, and the like. Also, the app program memory 152 may store applications downloaded from online markets or storefronts. Meanwhile, the process memory 153 may store data temporarily created while an application stored in the app program memory 152 is executed under the control of the control unit 160.

The control unit 160 typically controls the operations of the mobile device, and controls signal flows between elements of the mobile device, and processes data. The control unit 160 typically also controls power supply from a battery to the elements or parts of the device. Additionally, the control unit 160 may execute various kinds of applications stored in the program region. Particularly, when a multi touch or a multi touch gesture occurs, the control unit 160 may perform a particular corresponding function. For example, if a pinch-in gesture occurs on the touch screen 110, the control unit 160 may perform at least one of an app execution termination function and a touch screen turn-off function. In the latter case, the control unit 160 may turn off the entire touch screen 110, i.e., both the display panel 112 and the touch panel 111, or turn off the display panel 112 only—leaving the touch panel 111 powered on and able to detect touches or other inputs on the device. Furthermore, if a pinch-out gesture occurs on the touch screen 110 in which the display panel 112 only is turned off—and the touch panel 111 is not turned off, the control unit 160 may perform a turn-on function for the display panel 112 of the touch screen 110.

If an app icon displayed on the home screen is selected, the control unit 160 may execute a corresponding application stored in the memory unit 140. The control unit 160 may then store, in the process memory 153, various data temporarily created in information processing tasks for execution of the particular application.

Specifically, the control unit 160 may include a detection part 161, a judgment part 162, and an execution part 163.

The detection part 161 of the control unit 160 is connected to the touch screen 110 (and optionally connected to the key input unit 120) and may detect a touch gesture from the touch screen 110. The detection part 161 may detect position coordinates of a multi touch through three or more touch input signals received from the touch screen 110, and then deliver the position coordinates to the judgment part 162. The detection part 161 may detect coordinates of touch points, a form of touch gesture, a direction and distance of touch movement, and the like.

The judgment part 162 of the control unit 160 may determine, based on a change in position coordinates, whether there is a touch movement. Namely, if the position coordinates of touch points are changed, the judgment part 162 may determine that a touch movement occurs. In this case, the judgment part 162 may further determine whether such a touch movement is a pinch-in gesture.

In one embodiment, the judgment part 162 may calculate position vectors using direction and distance of movements of multi-touched contact points and then determine whether a touch movement is a pinch-in gesture, depending on whether the calculated position vectors get nearer to their center. In another embodiment, the judgment part 162 may define a polygonal outline which connects multi-touched contact points in their initial positions. Then the judgment part 162 may determine whether a touch movement is a pinch-in gesture, depending on whether coordinates of touched contact points move inward from the polygonal outline from their initial positions. Additionally, the judgment part 162 may determine whether a screen displayed at the time of a pinch-in gesture is a home screen or an app execution screen. The judgment part 162 may additionally determine whether a pinch-out gesture is detected within a given time (e.g., 3˜4 seconds).

The execution part 163 of the control unit 160 may execute a particular function, e.g., an app execution termination function and/or a touch screen turn-off function, corresponding to a pinch-in gesture when the pinch-in gesture is detected. Additionally, the execution part 163 may execute a particular function, e.g., a touch screen turn-on function, corresponding to a pinch-out gesture when the pinch-out gesture is detected.

If an app execution termination function is defined as a particular function corresponding to a pinch-in gesture, the control unit 160 may terminate the execution of a selected application in response to a pinch-in gesture such that the application may not occupy any portion of the memory 150. If a touch screen turn-off function is defined as a particular function corresponding to a pinch-in gesture, the control unit 160 may turn off the touch screen in response to a pinch-in gesture. If both an app execution termination function and a touch screen turn-on function are defined as a particular function corresponding to a pinch-in gesture, the control unit 160 may terminate the execution of a selected application and also turn off the touch screen in response to a pinch-in gesture.

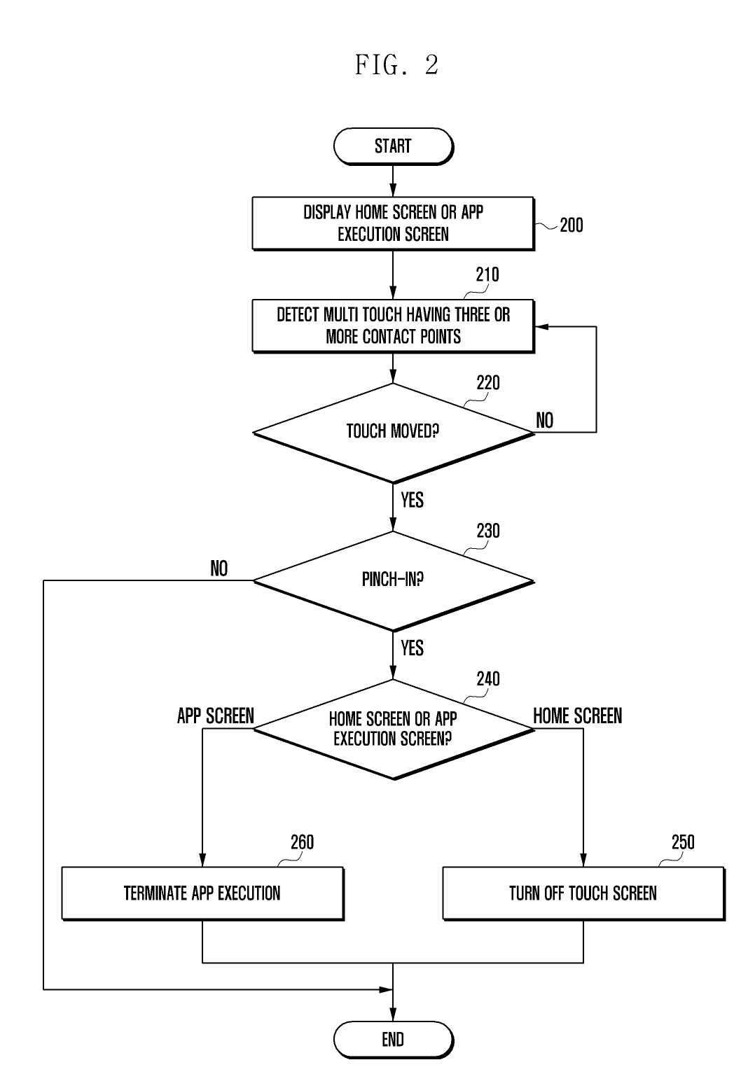

FIG. 2 is a flow diagram illustrating a user interaction method in accordance with an embodiment of the present invention.

Referring to FIG. 2, at step 200, the control unit 160 may display a home screen or an app execution screen on the display panel 112 of the touch screen 110. At step 210, the control unit 160 may detect a finger-based multi touch having three or more contact points from the touch screen 110 on which a home screen or an app execution screen is displayed. A finger-based multi touch refers to a state where any contact occurs at some points on the touch screen by a touch of user fingers. The control unit 160 may simultaneously or sequentially detect contact points on the touch screen.

Once a finger-based multi touch is detected, the touch screen 110 creates touch input signals corresponding to touched contact points and sends the created signals to the control unit 160. This input signal may include information about x, y coordinates. The control unit 160 may detect position coordinate values of touched contact points from received touch input signals.

At step 220, the control unit 160 may determine whether there is a movement of one or more of the contact points. The touch screen 110 may periodically send touch input signals to the control unit 160 until a multi touch is released, i.e., when there are no longer at least three contact points. The control unit 160 may then recognize a movement of a multi touch, based on the touch input signals received periodically from the touch screen 110. Depending on periodically received touch input signals, the control unit 160 may determine whether position coordinates of initially touched contact points are changed. The control unit 160 may additionally detect direction, distance, speed, etc. of a touch movement on the basis of touch contact points and the periodically detected touch contact points. For example, the control unit 160 may detect a touch move direction and a touch move distance on the basis of initially touched contact points.

The control unit 160 may additionally detect a speed of a multi touch, based on the time interval between touch-on and touch-off. Using touch input signals collected for a given time, e.g., for 3˜4 seconds, the control unit 160 may determine a touch movement. Also, using all touch input signals created from time when any contact of a multi touch occurs to time when all contacts of a multi touch are released, the control unit 160 may determine a touch movement. If there is no touch movement, the control unit 160 may return to step 210.

At step 230, the control unit 160 may determine, using a change in positions of contact points, whether a touch movement is a pinch-in. For example, the control unit 160 may calculate position vectors using direction and distance of movements of touched contact points and then determine whether a touch movement is a pinch-in, depending on whether the calculated position vectors converge. Alternatively, the control unit 160 may define a polygonal outline which connects three or more touched contact points and then determine whether a touch movement is a pinch-in, depending on whether coordinates of touched contact points move inward from the polygonal outline.

At this step, the control unit 160 may further determine whether a move distance of a multi touch exceeds a given distance. If a move distance of a multi touch exceeds a given distance, namely if a change in contact points is greater than a given value, the control unit 160 can detect the occurrence of a pinch-in. However, if a move distance of a multi touch does not exceed a given distance, the control unit 160 may not detect the occurrence of a pinch-in. If a touch movement is not a pinch-in gesture, the control unit 160 may end a process and maintain a currently displayed screen. The threshold for the “given distance” may be a variable set by the user or alternatively, be coded into the OS.

At step 240, the control unit 160 may determine whether a screen presently displayed on the display panel 112 is a home screen or an app execution screen. If a displayed screen is a home screen, the control unit 160 may turn off the touch screen 110 at step 250 as a function corresponding to a pinch-in. For this turn-off function, the control unit 160 may stop supplying power to the touch panel 111 and the display panel 112. After being turned off, the touch panel 111 and the display panel 112 may be turned on through a specific input signal from the key input unit 120 under the control of the control unit 160.

If a presently displayed screen is an app execution screen, the control unit 160 may terminate the execution of a displayed application at step 260. Namely, the control unit 160 may terminate a currently displayed and running application (preferably along with its associated processes) such that the application may no longer occupy any portion of the memory unit 150. The control unit 160 may then display a home screen on the display panel 112 of the touch screen 110.

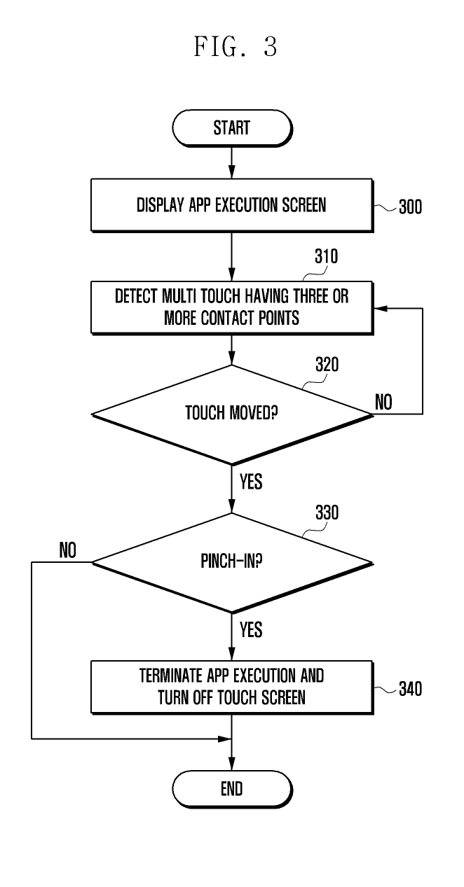

FIG. 3 is a flow diagram illustrating a user interaction method in accordance with another embodiment of the present invention.

Referring to FIG. 3, at step 300, the control unit 160 may display an app execution screen on the display panel 112.

At step 310, the control unit 160 may detect a finger-based multi touch having three or more contact points from the touch screen 110 on which an app execution screen is displayed. The control unit 160 may detect position coordinate values of touched contact points from touch input signals received from the touch screen 110.

At step 320, the control unit 160 may determine whether there is a movement of a multi touch. Namely, depending on received touch input signals, the control unit 160 may determine whether position coordinate values of initially touched contact points are changed. The control unit 160 may additionally detect direction, distance, speed, etc. of a touch movement on the basis of touch contact points. For example, the control unit 160 may detect a touch move direction and a touch move distance on the basis of initially touched contact points.

Additionally, the control unit 160 may detect a speed of a multi touch, based on the time interval between touch-on and touch-off. Namely, using touch input signals collected for a given time, e.g., for 3˜4 seconds, the control unit 160 may determine a touch movement. Also, using all touch input signals created from time when any contact of a multi touch occurs to time when all contacts of a multi touch are released, the control unit 160 may determine a touch movement. If there is no touch movement, the control unit 160 may return to step 310.

At step 330, the control unit 160 may determine, using a change in positions of contact points, whether a touch movement is a pinch-in. For example, the control unit 160 may calculate position vectors using direction and distance of movements of touched contact points and then determine whether a touch movement is a pinch-in, depending on whether the calculated position vectors converge. Alternatively, the control unit 160 may define a polygonal outline which connects three or more touched contact points and then determine whether a touch movement is a pinch-in, depending on whether coordinates of touched contact points move inward from the polygonal outline or otherwise define a polygon having a smaller perimeter.

At this step, the control unit 160 may further determine whether a move distance of a multi touch exceeds a given distance. If a move distance of a multi touch exceeds a given distance, namely if a change in contact points is greater than a given value, the control unit 160 can detect the occurrence of a pinch-in gesture. However, if a move distance of a multi touch does not exceed a given distance, the control unit 160 may not detect the occurrence of a pinch-in gesture. If a touch movement is not a pinch-in gesture, the control unit 160 may end a process and maintain a currently displayed screen.

If a pinch-in gesture is detected from an app execution screen, the control unit 160 may turn off the touch screen 110 and also terminate the execution of a currently running application at step 340 such that the application no longer occupies memory. At this time, for turn-off of the touch screen 110, the control unit 160 may stop supplying power to the touch panel 111 and the display panel 112. After being turned off, the touch panel 111 and the display panel 112 may be turned on through a specific input signal from the key input unit 120 under the control of the control unit 160.

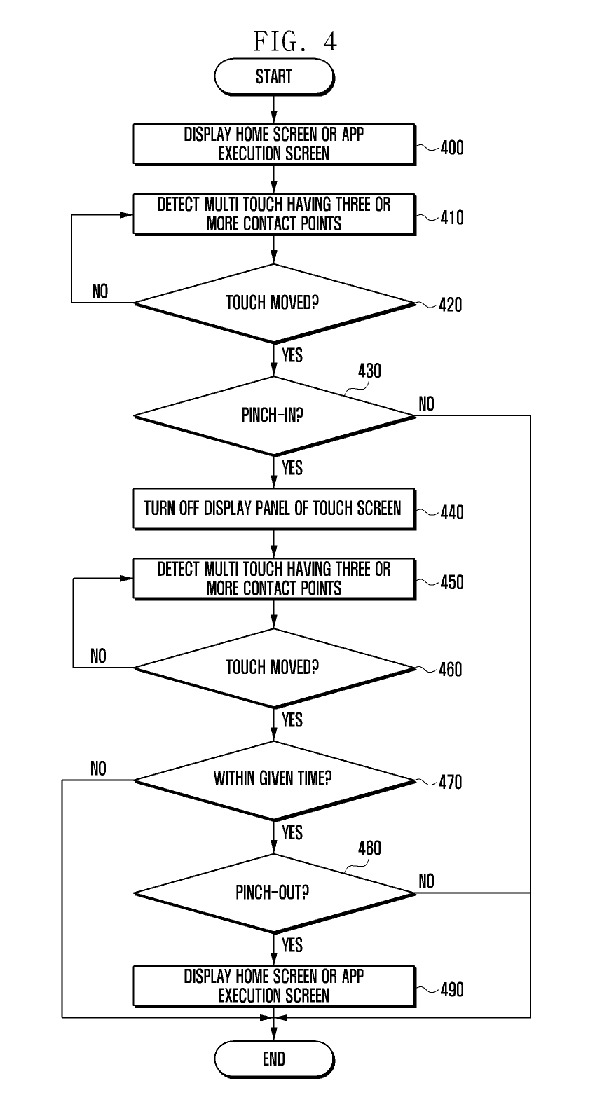

FIG. 4 is a flow diagram illustrating a user interaction method in accordance with still another embodiment of the present invention.

Referring to FIG. 4, at step 400, the control unit 160 may display a home screen or an app execution screen on the display panel 112 of the touch screen 110.

At step 410, the control unit 160 may detect a finger-based multi touch having three or more contact points from the touch screen 110 on which a home screen or an app execution screen is displayed. A finger-based multi touch refers to a state where any contact occurs at some points on the touch screen by a touch of user fingers. The control unit 160 may simultaneously or sequentially detect contact points on the touch screen.

Once a finger-based multi touch is detected, the touch screen 110 creates touch input signals corresponding to touched contact points and sends the created signals to the control unit 160. This input signal may include information about x, y coordinates of each touched contact point. The control unit 160 may detect position coordinate values of touched contact points from received touch input signals.

At step 420, the control unit 160 may determine whether there is a movement of a multi touch having three or more contact points. The touch screen 110 may send periodically touch input signals to the control unit 160 until a multi touch is released. Then the control unit 160 may recognize a movement of a multi touch, based on the touch input signals received periodically from the touch screen 110. Depending on periodically received touch input signals, the control unit 160 may determine whether position coordinates of initially touched contact points are changed. The control unit 160 may additionally detect direction, distance, speed, etc. of a touch movement on the basis of the touch contact points over time. For example, the control unit 160 may detect a touch move direction and a touch move distance on the basis of initially touched contact points.

Additionally, the control unit 160 may detect a speed of a multi touch, based on the time interval between touch-on and touch-off. Using touch input signals collected for a given time, e.g., for 3˜4 seconds, the control unit 160 may determine a touch movement. Using all touch input signals created from time when any contact of a multi touch occurs to time when all contacts of a multi touch are released, the control unit 160 may determine a touch movement. If there is no touch movement, the control unit 160 may return to step 410.

At step 430, the control unit 160 may determine, using a change in positions of contact points, whether a touch movement is a pinch-in. For example, the control unit 160 may calculate position vectors using direction and distance of movements of touched contact points and then determine whether a touch movement is a pinch-in, depending on whether the calculated position vectors get near to their center or converge. Alternatively, the control unit 160 may define a polygonal outline which connects three or more touched contact points and then determine whether a touch movement is a pinch-in, depending on whether coordinates of touched contact points move inward from the polygonal outline.

At this step, the control unit 160 may further determine whether a move distance of a multi touch exceeds a given distance. If a move distance of a multi touch exceeds a given distance, namely if a change in contact points is greater than a given value, the control unit 160 can detect the occurrence of a pinch-in gesture. However, if a move distance of a multi touch does not exceed a given distance, the control unit 160 may not detect the occurrence of a pinch-in gesture, or the control unit 160 may be instructed to read the occurrence as something other than a pinch-in gesture. If a touch movement is not a pinch-in gesture, the control unit 160 may end a process and maintain a currently displayed screen.

If a pinch-in gesture is detected from the touch screen 110, the control unit 160 turns off the display panel 112. At this time, for turn-off of the touch screen 110, the control unit 160 may, e.g., stop supplying power to the display panel 112 only. Therefore, even though the display panel 112 is turned off, the touch panel 111 can detect user's touch. Alternatively, the control unit 160 may switch the displayed screen to a different screen, being neither an app execution screen nor a home screen. Meanwhile, the control unit 160 may store in the memory unit 150 a screen, together with related information, displayed on the display panel 112 when the touch screen 110 is turned on or off. Such an alternate screen may be a “lock screen”.

At step 450, the control unit 160 may detect a multi touch having three or more contact points from the touch screen 110 in which the display panel 112 only is turned off. At step 460, the control unit 160 may determine whether there is a movement of a multi touch having three or more contact points. If there is a movement of a multi touch, the control unit 160 may determine at step 470 whether a movement of a multi touch is detected within a given time. If there is no movement of a multi touch, the control unit 160 may return to step 450.

If a movement of a multi touch is detected within a given time, the control unit 160 determines at step 480 whether a movement of a multi touch is a pinch-out gesture. For example, the control unit 160 may calculate position vectors using direction and distance of movements of touched contact points and then determine whether a touch movement is a pinch-out, depending on whether the calculated position vectors become distant from their center or diverge. Alternatively, the control unit 160 may define a polygonal outline which connects three or more touched contact points and then determine whether a touch movement is a pinch-out, depending on whether coordinates of touched contact points move outward from the polygonal outline.

At this step, the control unit 160 may further determine whether a move distance of a multi touch exceeds a given distance, similar to that which is described above. If a move distance of a multi touch exceeds a given distance, namely if a change in contact points is greater than a given value, the control unit 160 may determine that a pinch-out occurs. However, if a move distance of a multi touch does not exceed a given distance, the control unit 160 may determine that such a movement is not a pinch-out.

After a pinch-out is detected, the control unit 160 may turn on the display panel 112 of the touch screen 110 at step 490 by supplying power thereto. In one embodiment, the control unit 160 may display on the display panel 112 a specific screen which has been stored at the time of turn-off. Specifically, if a pinch-in gesture occurs on an app execution screen, the control unit 160 stores the displayed app execution screen and turns off the display panel 112. Thereafter, if a pinch-out gesture occurs within a given time, the control unit 160 turns on the display panel 112 and displays the stored app execution screen on the display panel 112, as if the display panel 112 was never turned off. Similarly, if a pinch-in gesture occurs on a home screen, the control unit 160 stores the displayed home screen and turns off the display panel 112. Thereafter, if a pinch-out gesture occurs within a given time, the control unit 160 turns on the display panel 112 and displays the stored home screen on the display panel 112. More particularly, when the display panel 112 is de-energized, but the touch screen 110 is active, and the control unit 160 detects a pinch-in gesture, the control unit 160 effectively returns the device to the same display on the display panel 112 when the screen was de-energized.

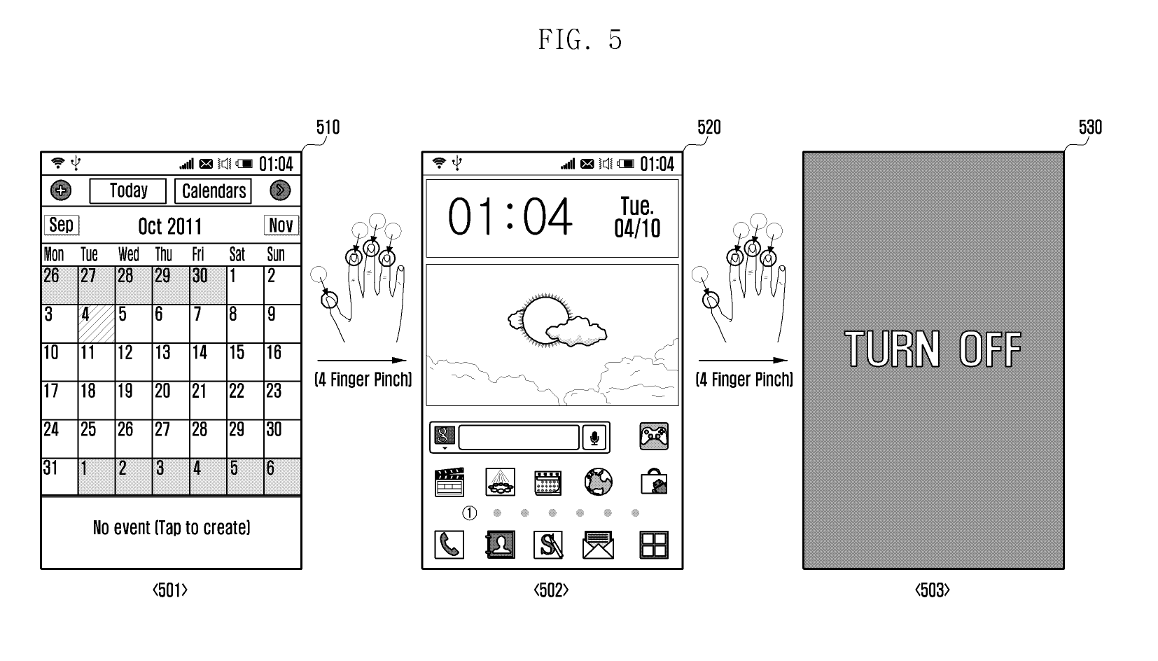

FIG. 5 shows screenshots associated with a user interaction method in accordance with an embodiment of the present invention.

Referring to FIG. 5, the display panel 112 of the touch screen 110 may display a selected app execution screen, e.g., a scheduler or calendar app execution screen 510, under the control of the control unit 160 as shown in screenshot 501. The scheduler app execution screen 510 may be displayed in a calendar display mode on the display panel 112.

While the scheduler app execution screen 501 is displayed, a user may make a pinch-in gesture on the touch screen 110. When a pinch-in gesture is detected from the touch screen 110 on which the scheduler app execution screen 510 is displayed, the control unit 160 may terminate the execution of a scheduler application displayed on the display panel 112 such that the scheduler application no longer occupies a portion of a memory. Then, as shown in screenshot 502, the control unit 160 may display a home screen 520 on the display panel 112. The home screen 520 may contain one or more icons for executing applications or invoking functions of a mobile device.

While the home screen 520 is displayed, a user may make a pinch-in gesture on the touch screen 110. When a pinch-in gesture is detected from the touch screen 110 on which the home screen 520 is displayed, the control unit 160 may turn off both the display panel 111 and the touch panel 112 such that no screen may appear on the touch screen 110 as shown in screenshot 503.

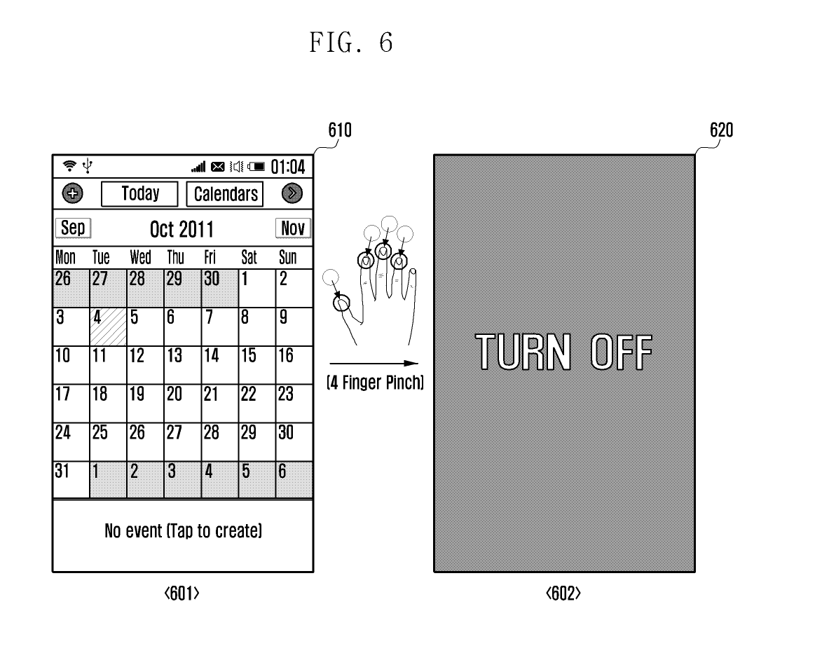

FIG. 6 shows screenshots associated with a user interaction method in accordance with another embodiment of the present invention.

Referring to FIG. 6, the display panel 112 of the touch screen 110 may display a selected app execution screen, e.g., a scheduler app execution screen 610, under the control of the control unit 160 as shown in screenshot 601. The scheduler app execution screen 610 may be displayed in a calendar display mode on the display panel 112. While the scheduler app execution screen 610 is displayed, a user may make a pinch-in gesture on the touch screen 110. When a pinch-in gesture is detected from the touch screen 110 on which the scheduler app execution screen 610 is displayed, the control unit 160 may terminate the execution of a scheduler application displayed on the display panel 112. At the same time, the control unit 160 may turn off the touch screen 110 by removing power from the display panel 112. Thus, as shown in screenshot 602, no screen 620 may appear on the touch screen 110.

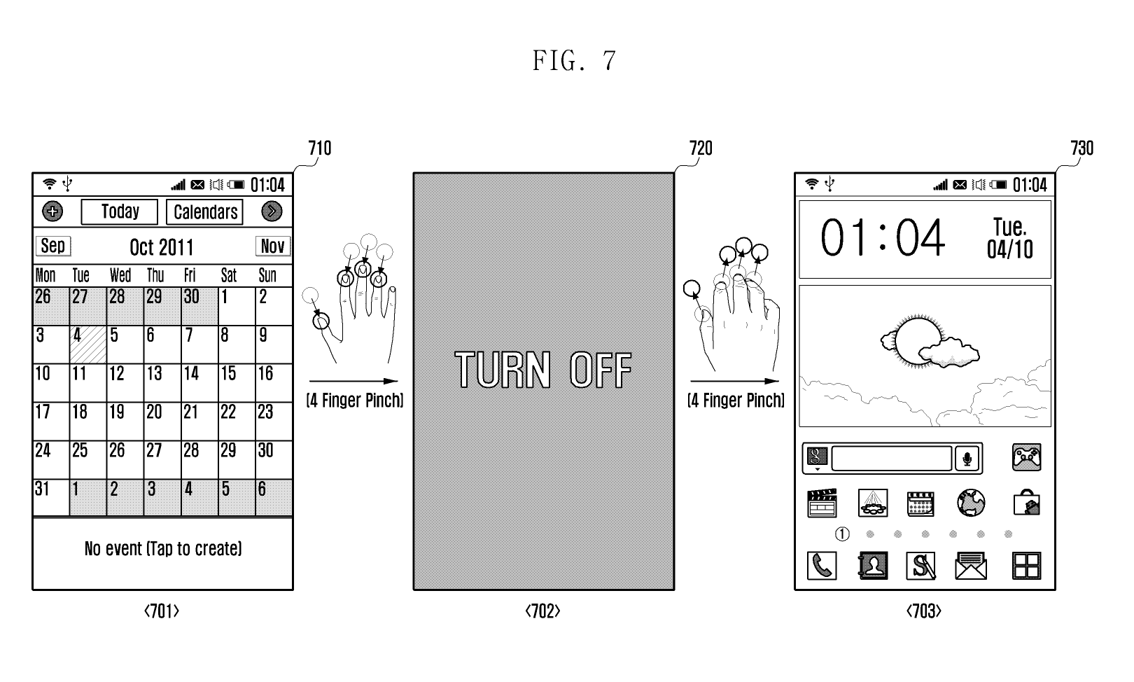

FIG. 7 shows screenshots associated with a user interaction method in accordance with still another embodiment of the present invention.

Referring to FIG. 7, the display panel 112 of the touch screen 110 may display a selected app execution screen, e.g., a scheduler app execution screen 710, under the control of the control unit 160 as shown in screenshot 701. The scheduler app execution screen 710 may be displayed in a calendar display mode on the display panel 112. While the scheduler app execution screen 710 is displayed, a user may make a pinch-in gesture on the touch screen 110. When a pinch-in gesture is detected from the touch screen 110 on which the scheduler app execution screen 710 is displayed, the control unit 160 may terminate the execution of a scheduler application displayed on the display panel 112. At the same time, the control unit 160 may turn off the display panel 112 as shown in screenshot 702 such that no screen 720 may appear on the display panel 112.

After the display panel 112 is turned off, a user may make a pinch-out gesture on the touch screen 110. When a pinch-out gesture is detected from the touch screen 110 in which the display panel 112 is turned off, the control unit 160 may display a home screen 730 on the display panel 112 as shown in screenshot 703.

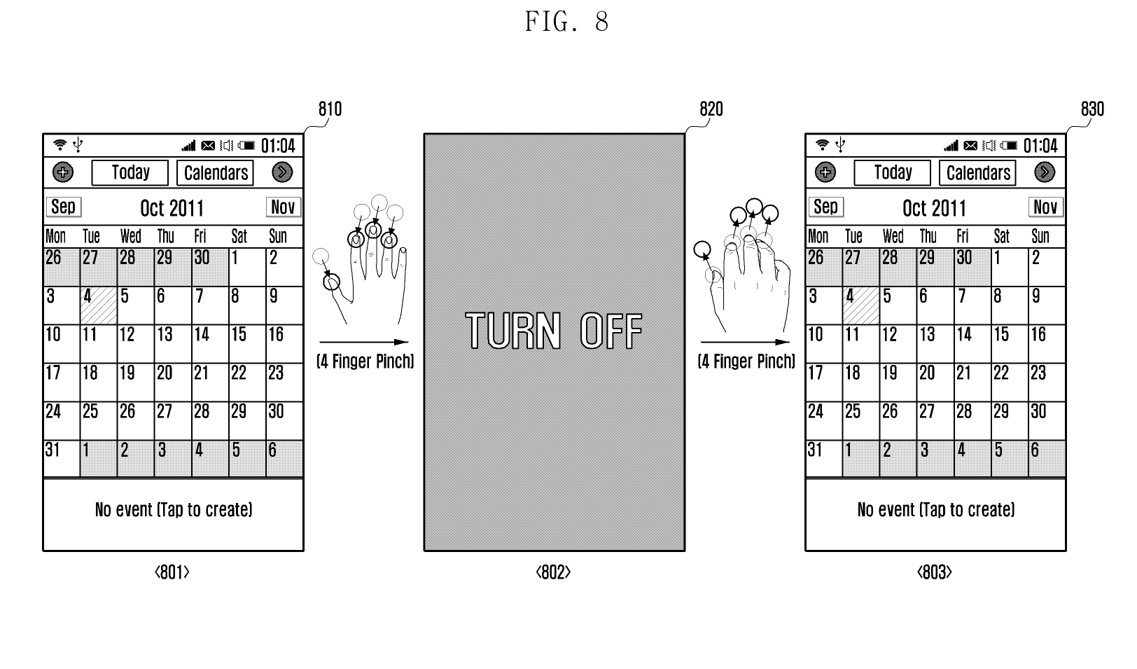

FIG. 8 shows screenshots associated with a user interaction method in accordance with yet another embodiment of the present invention.

Referring to FIG. 8, the display panel 112 of the touch screen 110 may display a selected app execution screen, e.g., a scheduler app execution screen 810, under the control of the control unit 160 as shown in screenshot 801. The scheduler app execution screen 810 may be displayed in a calendar display mode on the display panel 112.

While the scheduler app execution screen 810 is displayed, a user may make a pinch-in gesture on the touch screen 110. When a pinch-in gesture is detected from the touch screen 110 on which the scheduler app execution screen 810 is displayed, the control unit 160 may turn off the display panel 112 as shown in screenshot 802 such that no screen 820 may appear on the display panel 112.

After the display panel 112 is turned off, a user may make a pinch-out gesture on the touch screen 110. When a pinch-out gesture is detected from the touch screen 110 in which the display panel 112 is turned off, the control unit 160 may display an app execution screen 830 on the display panel 112 as shown in screenshot 803. In this embodiment, the control unit 160 may store a screen displayed on the display panel 112 at the time the display panel 112 was turned off and then, when a pinch-out gesture occurs, may display the stored screen on the display panel 112.

In one embodiment, the control unit 160 can be configured to display the stored screen on the display panel only if the time duration between the pinch-out gesture and the pinch-in gesture occur within a predetermined period of time. This period can be any time unit (preferably on the order of 1 minute), either as set by the user or coded into the OS. Should the duration be greater than this time unit, the control unit 160 can be configured to perform a variety of functions, e.g., de-energize the touch screen 110 and ignore the pinch-in gesture—thereby requiring the user to utilize a different method to wake the device; display a home screen on the display unit 112, or display any other screen/message as set by the user or coded into the OS. Although in the above embodiments a touch screen turn-on function is described as being executable when a pinch-out gesture is detected within a given time, this is exemplary only and not to be considered as a limitation of the invention. Alternatively, regardless of such a given time, the display panel of the touch screen may be turned on in response to a pinch-out gesture. In this case, a pinch-out gesture may be used to invoke an unlock function. Moreover, it is considered within the scope of the present invention to swap any of the pinch-in gestures as described herein, with a pinch-out gesture.

According to a digital convergence tendency today, the mobile device may essentially or selectively further include any other elements such as a sensor module for detecting information related to location variations of the mobile device, a GPS module for measuring the location of the mobile device, a camera module, and the like. Meanwhile, as will be understood by those skilled in the art, some of the above-mentioned elements in the mobile device may be omitted or replaced with another. In addition to the touch screen 110 and the key input unit 120, the mobile device of this invention may further include a touch pad, a trackball, etc. as an input unit.

The above-described methods according to the present invention can be implemented in hardware, firmware or the execution of software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for interaction with an apparatus having a touch screen, the method comprising:
detecting a multi touch having at least three contact points on the touch screen on which an app execution screen is displayed;
detecting a movement of at least one of the contact points of the multi touch on the touch screen by a control unit;
when the movement of the multi touch is a pinch-in, performing at least one function, the at least one function including an app execution termination function and a touch screen turn-off function.

2. The method of claim 1, wherein the detecting the movement of the multi touch includes detecting one or more of direction, distance, and speed of at least one of the contact points by using position coordinates of the contact points.

3. The method of claim 1, wherein the detecting the movement of the multi touch is performed based on a change in coordinates of the contact points collected within a given time.

4. The method of claim 1, wherein the determining whether the movement of the multi touch is a pinch-in includes:
calculating position vectors using direction and distance of movements of at least one of the contact points;
determining whether the calculated position vectors converge toward a center thereof; and
when the calculated position vectors converge toward a center thereof, determining that the movement of the multi touch is a pinch-in.

5. The method of claim 1, wherein the determining whether the movement of the multi touch is a pinch-in includes:
defining a polygonal outline connecting the contact points;
determining whether position coordinates of the contact points move inward from the polygonal outline; and
when the position coordinates of the contact points move inward from the polygonal outline, determining that the movement of the multi touch is a pinch-in.

6. The method of claim 4, wherein the determination of a pinch-in includes:
determining whether a move distance of the contact points exceeds a predetermined distance; and
when the move distance of the contact points exceeds the given distance, determining that the movement of the multi touch is a pinch-in.

7. The method of claim 1, wherein the performing the touch screen turn-off function includes turning off at least one of a display panel and a touch panel of the touch screen.

8. The method of claim 1, wherein the at least one function comprises a touch-screen turn-off function, the method thereafter further comprising:
detecting a multi touch having at least three contact points from the touch screen which is turned off;
detecting a movement of at least one contact point of the multi touch; and
when the movement of the multi touch is a pinch-out, performing a touch screen turn-on function.

9. The method of claim 8, further comprises:
calculating position vectors using direction and distance of movements of the contact points;
determining whether the calculated position vectors diverge from a center thereof; and
when the calculated position vectors diverge from a center thereof, determining that the movement of the multi touch is a pinch-out.

10. The method of claim 8, further comprises:
defining a polygonal outline connecting each of the contact points;
determining whether position coordinates of the contact points move outward from the polygonal outline; and
when the position coordinates of the contact points move outward from the polygonal outline, determining that the movement of the multi touch is a pinch-out.

11. The method of claim 8, further comprises:
determining whether a move distance of the contact points exceeds a predetermined distance; and
when the move distance of the contact points exceeds the predetermined distance, determining that the movement of the multi touch is a pinch-out.

12. A user interaction apparatus comprising:
a touch screen comprising a display panel and a touch panel;
a memory unit configured to store information about a multi touch gesture and information about a particular function corresponding to the multi touch gesture; and
a control unit configured to detect a multi touch on the touch screen, the multi touch comprising at least three contact points on which an app execution screen is displayed, to detect a movement of the multi touch, to determine based on the information stored in the memory unit whether the movement of the multi touch is a pinch-in, and to perform at least one function, based on the information stored in the memory unit, the at least one function comprising at least one of an app execution termination function and a touch screen turn-off function if the movement of the multi touch is a pinch-in.

13. The apparatus of claim 12, wherein the control unit is further configured to detect one or more of direction, distance, and speed of a touch by using position coordinates of the contact points.

14. The apparatus of claim 12, wherein the control unit is further configured to detect the movement of the multi touch based on a change in coordinates of the contact points collected within a given time.

15. The apparatus of claim 12, wherein the control unit is further configured to calculate position vectors using direction and distance of movements of the contact points, and when the calculated position vectors converge toward a center thereof, to determine that the movement of the multi touch is a pinch-in.

16. The apparatus of claim 12, wherein the control unit is further configured to define a polygonal outline connecting the contact points, and when position coordinates of the contact points converge from the polygonal outline, to determine that the movement of the multi touch is a pinch-in.

17. The apparatus of claim 12, wherein the control unit is further configured to detect a pinch-out gesture from the touch screen which is turned off, and to perform a touch screen turn-on function in response to the pinch-out gesture.

18. The apparatus of claim 17, wherein the control unit is further configured to determine whether the pinch-out gesture is detected within a given time, and to perform a touch screen turn-on function when the pinch-out gesture is detected within a given time.

19. The apparatus of claim 17, wherein the control unit is further configured to store in the memory unit a screen displayed on the touch screen at the time of the pinch-in gesture, and to recall the screen displayed from the memory unit and display the stored screen on the touch screen in response to the pinch-out gesture.
